(19) United States
(12) Patent Application Publication
(10) Pub. No.: US 2005/0221024 A1
(43) Pub. Date: Oct. 6, 2005

(54) Ink jet recording sheet

(76) Inventors: Rie Teshima, Tokyo (JP); Hirokazu Sunagawa, Tokyo (JP); Satoshi Matsuura, Chiba-shi (JP); Kazuo Totani, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/062,041

(22) Filed: Feb. 18, 2005

(30) Foreign Application Priority Data
Feb. 23, 2004 (JP) 2004-045612
Mar. 25, 2004 (JP) 2004-090560

(51) Int. Cl. B41M 5/00

(52) U.S. Cl. 428/32.3

(57) ABSTRACT

Ink jet recording sheet has excellent coating strength, print water resistance, print concentration, ink absorptivity, and white paper portion preservability, and possesses excellent coloring properties for dye ink as well as pigment ink. The ink jet recording sheet includes: a supporting medium; and an ink receiving layer disposed on the supporting medium, the ink receiving layer including, at least: pigment; an adhesive; and an ink fixing agent, wherein the ink fixing agent includes at least one compound selected from the group consisting of zinc chloride, zinc sulfite, magnesium chloride and magnesium sulfate, in combination with a guanidine compound.

Priority is claimed on Japanese Patent Application No. 2004045612, filed Feb. 23, 2004, and Japanese Patent Application No. 2004-090560, filed Mar. 25, 2004, the contents of which are incorporated herein by reference.

### BACKGROUND OF THE INVENTION

1. Field of the Invention

The present invention relates to ink jet recording sheets and to printed matter using the ink jet recording sheets. More specifically, the present invention relates to an ink jet recording sheet which is excellent in, as ink jet recording characteristics, printing concentration for dye ink as well as pigment ink, is capable of clearly printing an image of high fineness, and printing preservability (especially, print light resistance and print ozone resistance). Furthermore, the present invention relates to ink jet recording sheet having an excellent coating surface strength and preservability in a white paper portion, and does not deteriorate the above-mentioned characteristics when paper material in which pulp recycled from waste paper is used.

2. Description of Related Art

Ink jet recording systems in which aqueous ink is ejected through a nozzle having fine pores to form an image on a recording medium is widely used in terminal prints, facsimiles, plotters, sheet feeding printers, etc., due to low noise during recording, ease of performing color recording, possibility of performing high-speed recording, lower cost than other printing devices, and so forth.

The aqueous ink may be categorized into dye ink which includes dye and pigment ink which includes pigment, and the dye ink is mainly used due to its clearness. However, since the dye ink is often used for large posters displayed outdoors recently, disadvantages of the dye ink have become conspicuous in that it is easily oxidized by ultraviolet rays, ozone, etc., during long-term exhibition to cause discoloration and deterioration in appearance of the image, and a sufficient light resistance of the printed image cannot be obtained.

On the other hand, although the pigment ink has advantageous characteristics that it has excellent light resistance, ozone resistance, and water resistance of the printed image, there is a problem in that a clear printed image cannot be obtained using a conventional ink jet recording sheet for dye ink since the particle size of the pigment ink is significantly larger than that of the dye ink.

For the reasons described above, although both the ink jet recording sheet for dye ink and the ink jet sheet for pigment ink have been developed, demand for an ink jet recording sheet having an excellent coloring property for both dye ink and pigment ink has increased. Also, due to the improvement in the preservability of the printed portion using pigment ink, a coating strength of a printed surface and preservability of a white paper portion (or unprinted portion) are becoming increasingly regarded as important. Since printed matter is formed by printed portion and white paper portion, an ink jet recording sheet which satisfies the abovementioned coloring properties and possesses excellent preservability in white paper portion is required.

As a method for obtaining an ink jet recording sheet which exhibits excellent water resistance, print concentration, and so forth, using dye ink, various methods have been proposed, such as a method in which a water soluble metal salt or a metal oxide is included in a coating solution (for example, refer to Japanese Unexamined Patent Application, First Publication No. 2002274022), a method in which two or more coating layers are formed (for example, refer to Japanese Examined Patent Application, Second Publication No. Sho 63-11158, Japanese Unexamined Patent Application, First Publication No. Sho 58-94491, Unexamined Patent Application, First Publication No. Sho 6067190, Japanese Unexamined Patent Application, First Publication No. Sho 61-74880, Japanese Unexamined Patent Application, First Publication No. Hei 7-149037, Japanese Unexamined Patent Application, First Publication No. Hei 9-99630, Japanese Unexamined Patent Application, First Publication No. Hei 9-267546, Japanese Unexamined Patent Application, First Publication No. Hei 4-201594, and Japanese Unexamined Patent Application, First Publication No. Hei 7-32725). However, the ink jet recording sheet obtained by using the above method may have insufficient coloring property when printed on using dye ink or may have inferior coloring property and print preservability (water resistance, light resistance and ozone-resistance) when printed on using dye ink, and an ink jet recording sheet capable of yielding excellent recording properties, such as coloring property aud print preservability, using both the dye ink and the pigment ink is currently not available.

Also, as a method for obtaining an ink jet recording sheet which exhibits excellent coloring properties using dye ink as well as pigment ink, various methods have been proposed, such as a method in which a water soluble metal salt and vapor phase silica are included in a coating solution (for example, refer to Japanese Unexamined Patent Application, First Publication No. 2002-274022), a method in which two or more layers of ink receiving layer are formed (for example, refer to Japanese Unexamined Patent Application, First Publication No. 2000-168228, Japanese Unexamined Patent Application, First Publication No. 2002-347330, and Japanese Unexamined Patent Application, First Publication No. Hei 10-278411). However, the coloring properties and the preservability of printed portion using dye ink are not satisfied by these methods, and the coating strength and the preservability of white paper portion are not improved.

On the other hand, it is proposed to improve the coloring properties by defining the Stöckigt sizing degree and eliminating uneven absorption of ink. However, the cording strength and the preservability of white paper portion are not yet improved.

### SUMMARY OF THE INVENTION

The present invention has been achieved in consideration of the above situation, and an object of the present invention includes to provide an ink jet recording sheet having excellent coloring property and coating strength for both dye ink and pigment ink, and having excellent preservability for portions printed by dye ink as well as white paper portion even when pulp recycled from waste paper is used. Another object of the present invention includes to provide an ink jet recording sheet having 60° specular gloss of 15% or less which satisfies the above-mentioned quality.

That is, the ink jet recording sheet of the present invention includes the following aspects:

(1) Ink jet recording sheet, including: a supporting medium; and an ink receiving layer disposed on the supporting medium, the ink receiving layer including, at least; pigment; an adhesive; and an ink fixing agent, wherein the ink firing agent includes at least one compound selected from the group consisting of zinc chloride, zinc sulfate, magnesium chloride and magnesium sulfite, in combination with a guanidine compound,

(2) The ink jet recording sheet according to (1) above, wherein the guanidine compound is a dicyandiamide (also called cyanoguanidine)-polyethylene amine copolymer.

(3) The ink jet recording sheet according to (1) or (2) above, further includes a secondary ammonium salt compound as the ink fixing agent.

(4) The ink jet recording sheet according to (3) above, wherein the secondary ammonium salt compound is a compound having an acrylamide-diallyl amine structure.

(5) The ink jet recording sheet according to any one of (1)-(4) above, wherein the pigment has an average secondary particle size of 2 to 12 μm.

(6) The ink jet recording sheet according to any one of (1)-(5) above, wherein the ink receiving layer further includes surface-treated silica whose surface has been treated by a surfactant.

(7) The ink jet recording sheet according to any one of (1)-(6) above, wherein the supporting medium is a paper material,

(8) The ink jet recording sheet according to (7) above, wherein the Stöckigt sizing degree of the paper material is 110 seconds or longer.

(9) The ink jet recording sheet according to (7) or (8) above, wherein 10% or more of pulp which forms the paper material is recycled pulp obtained from waste paper.

(10) The ink jet recording sheet according to any one of (1)-(9) above, wherein a 60° specular gloss defined by JIS-Z8741 of a surface of the ink jet recording sheet is 15% or less.

(11) Printed matter including the ink jet recording sheet according to any one of (1)-(10) above, which is printed using dye ink.

(12) Printed matter including the ink jet recording sheet according to any one of (1)-(10) above, which is printed using pigment ink.

### DETAILED DESCRIPTION OF THE INVENTION

The invention summarized above and defined by the enumerated claims may be better understood by referring to the following detailed description. This detailed description of particular preferred embodiments, set out below to enable one to build and use particular implementation of the invention, is not intended to limit the enumerated claims, but to serve as particular examples thereof.

Hereinafter, the present invention will be explained in detail.

### First Embodiment

(Layer Structure)

The present invention provides an ink jet recording sheet which includes: a supporting medium; and an ink receiving layer disposed on the supporting medium, the ink receiving layer including: pigment; an adhesive; and an ink fixing agent, wherein the ink fixing agent includes at least one compound selected from the group consisting of zinc chloride, zinc sulfate, magnesium chloride and magnesium sulfate, in combination with a guanidine compound.

Note that, according to the present invention, the ink receiving layer may be provided on both sides of the supporting medium. In such a case, it becomes possible to provide a clear print image on both sides of the ink jet recording sheet. Also, the ink receiving layer may be formed by a plurality of layers. Moreover, an undercoating layer may be provided between the supporting member and the ink receiving layer. Furthermore, an overcoating layer may be provided on the ink receiving layer in order to give glossiness or to improve the preservability, within a range not deteriorating the recording properties of the ink receiving layer.

(Supporting Medium)

The supporting medium is not particularly limited as long as it is a medium which can be used for ordinary ink jet recording paper. Examples thereof includes papers, such as woodfree paper, art paper, coated paper, cast-coated paper, foil paper, craft paper, baryta paper, impregnated paper, and vapor deposition paper; resin films, nonwoven fabrics, and resin-coated paper, such as one in which a resin film is attached to coated paper or woodfree paper via an adhesive, and one in which a resin is laminated on paper.

(Ink Receiving Layer)

According to the present invention, the ink receiving layer include, at least, pigment, an adhesive, and an ink fixing agent.

The pigment used for the ink receiving layer is not particularly limited as long as it is conventionally used for a coating layer or ink receiving layer of ink jet recording paper. Examples of the pigment include inorganic pigments, such as silica, precipitated calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, aluminum hydroxide, alumina, pseudoboehmite, lithopone, zeolite, hydrated halloysite, magnesium carbonate, and magnesium hydroxide; and organic pigments made of resins, such as an acryl or methacryl resin, a vinyl chloride resin, a vinyl acetate resin, a polyester resin, a styrene-acryl resin, a styrene-butadiene resin, a styrene-isoprene resin, a polycarbonate resin, a silicone resin, a urea resin, a melamine resin, an epoxy resin, a phenol resin, and a diallylphthalate resin. These resins may be in a spherical form or in an amorphous form, and may be porous or non-porous. Also, these pigments may be used singularly or in a combination of two or more.

Among these pigments, it is preferable to use silica, alumina, pseudoboehmite, precipitated calcium carbonate, and zeolite due to their excellent coloring and ink absorbing properties. Among them, it is more preferable to use silica, alumina, and pseudoboehmite, and it is most preferable to use silica.

As for the above-mentioned silica, use of amorphous silica is preferable. Methods for producing the silica are not particularly limited, and it may be produced by using an arc method, a dry method, a wet method (precipitation method, gel method), and so forth. Among these methods, the wet method is preferable since the silica produced by the method is suitable for the ink jet recording sheet for pigment ink as well as the ink jet recording sheet for dye ink.

When wet type silica is used, the average particle size of the secondary particle of the wet silica is preferably 2 to 12 μm, and more preferably 4 to 10 μm. If the average particle size is less than 2 μm, the absorptivity for dye ink of the ink jet recording sheet which includes such silica tends to be reduced. Also, since the light transmittance thereof will increase, light resistance of the image formed by dye ink as well as the coating strength tends to be reduced. Also, when this is used for ink jet recording sheet for pigment ink, disadvantages such as lowering in the fixation property of the pigment ink will be caused. If the average particle size of the secondary particle of the wet silica exceeds 12 μm, on the other hand, problems tend to be caused for the ink jet recording sheet for dye ink as well as the ink jet recording sheet for pigment ink, such as lowering in clearness of image and the generation of blurring of image due to surface roughness.

Note that the term “average particle size of silica” in this application is measured by using a call counter method, and it indicates a volume average particle size measured by using a sample of silica which is ultrasonically dispersed in distilled water for 30 seconds.

According to the present invention, it is preferable that the surface of at least a part of the pigment contained in the ink receiving layer be treated with a surfactant. That is, the surface of all of the pigment may be treated with a surfactant, or it is possible to use the surface treated pigment together with untreated pigment. The untreated pigment is the same as those explained above, and hence the explanation thereof will be omitted.

As the pigment whose surface is treated with a surfactant, it is possible to use the same pigments as described above, and it is preferable to use silica, alumina, pseudoboehmite, precipitated calcium carbonate, and zeolite. Among them, it is more preferable to use silica, alumina, and pseudoboehmite, and it is most preferable to use silica as described above.

Although the surfactant used for treating the surface of the pigment is not particularly limited as described for those mentioned above, it is preferable to use nonionic surfactant Examples of the nonionic surfactant include polyoxyethylenealkyl ether, polyoxyethylenepolyoxypropylene copolymer, and polyoxyetbylenepolyoxypropylenealkyl ether. Among these, one having a hydrophile-lipophile balance (HLB) value of 8.0 to 15.0 is preferable, and one having HLB value of 10.0 to 12.0 is more preferable.

As a method for treating the surface of pigment using a surfactant, one which is described in, for example, Japanese Unexamined Patent Application, First Publication, No. Hei 9-25440 may be adopted. That is, a dry mixing method may be adopted in which pigment, for example, wet type silica, and a surfactant, for example, polychain type nonionic surfactant, are mixed using a mixer, such as a high-speed stream mixer. In such a case, it is possible to add a surfactant directly to pigment, and it is also possible to add a surfactant which is diluted with a volatile solvent, such as ethanol, to pigment and mix these.

Moreover, it is possible to adopt a wet treatment method in which a predetermined amount of a surfactant, for example, a nonionic surfactant is added and mixed with an emulsion slurry solution of pigment, for example, wet type silica, and a spray-drying process is subsequently carried out. In the wet treatment method, if the surfactant is insoluble with water, it is preferable to strongly disperse the surfactant in water to form an emulsion in advance, sequentially add the emulsion to an emulsified slurry solution of pigment to be sufficiently mixed, and then carry out a drying process.

The surface of the silica which is treated by a surfactant using the method described above is considered to be covered by the surfactant.

The amount of surfactant added is preferably 0.1 to 30 parts, more preferably 0.5 to 20 parts, with respect to 100 parts of pigment. When silica which is covered by the surfactant within the above-mentioned range is included, it becomes possible to improve the coloring property and to obtain a clear image.

The adhesive used in the ink receiving layer is not particularly limited, and it is possible to use proteins, such as casein, soy bean protein, and synthesized protein; various starches, such as ordinary starch and oxidized starch, polyvinyl alcohol and derivatives thereof; cellulose derivatives, such as carboxymethyl cellulose and methyl cellulose; acryl resins which are polymers or copolymers of acrylic acid, methacrylic acid, acrylate, methacrylate, etc.; and conventionally known adhesives for ink jet recording, for example, vinyl resins, such as ethylene-vinylacetate copolymer. These adhesives may be used singularly or in combination of two or more.

Among the above adhesives, it is preferable to use polyvinyl alcohol due to its excellent adhesiveness with pigment. Polyvinyl alcohol derivatives, such as silanol denatured polyvinyl alcohol and cationized polyvinyl alcohol may also be suitably used.

According to the present invention, the ink receiving layer includes, as an ink fixing agent, a guanidine compound as a cationic polymer, and at least one compound selected from the group consisting of zinc chloride, zinc sulfate, magnesium chloride and magnesium sulfate, as a water soluble metal salt. Although the exact reason is not yet determined, by using a guanidine compound in combination with a compound selected from the group consisting of zinc chloride, zinc sulfate, magnesium chloride and magnesium sulfate, the coloring property of both the dye ink and the pigment ink is improved and, in particular, remarkably clear images may be obtained when printed on using pigment ink. Also, by using the above ink fixing agent, the print light resistance and print gas (mainly ozone gas) resistance may be improved when printed using dye ink.

It is preferable that the guanidine compound be a compound having a dicyandiamide-polyethylene amine structure from the viewpoints of coloring property and print preservability.

According to the present invention, it is possible to use known cationic polymer, other than the guanidine compound, as long as it does not deteriorate the effect of the guanidine compound. Examples of the known cationic polymer include: 1) polyalkylene polyamines or derivatives thereof, such as polyethylene amine and polypropylene polyamine; 2) acryl polymer having a secondary or tertiary amine group and/or a quaternary ammonium group; 3) polyvinyl amine, polyvinyl amidine, and 5-member ring amidines; 4) dimethylamine-epichlorohydrin copolymer; 5) diallyldimethyl ammonium-SO₂ copolymer; 6) diallylamine salt-SO₂ copolymer; 7) dimethyldiallyl ammonium chloride polymer; 8) homopolymer or copolymer of vinylbenzyl triallylammonium salt; 9) polymer of allyl amine salt; 10) dialkylaminoethyl(meth)acrylate quaternary salt copolymer, and 11) acrylamide-diacryl amine salt copolymer, which are commercially available.

Among the above, it is preferable to use, as the cationic polymer, a dicyandiamide-polyethyleneamine copolymer together with an acrylamide-diallyl amine copolymer. By using the dicyandiamide-polyethyleneamine copolymer together with the acrylamide-diallyl amine copolymer, excellent coloring property when printed using pigment ink and excellent coloring property and print preservability (especially, print light resistance and print ozone resistance) when printed using dye ink may be obtained.

The amount of the cationic polymer is adjusted to be 5 to 60 parts by mass, preferably 20 to 50 parts by mass, with respect to 100 parts by mass of pigment. If the amount of the cationic polymer is less than 5 parts by mass, coloring of image and the preservability of printed portion will be easily deteriorated. If the amount of the cationic polymer exceeds 60 parts by mass, on the other hand, the ink absorptivity and the clearness of image will be deteriorated and uneven color will result.

According to the present invention, although at least one compound selected from the group consisting of zinc chloride, zinc sulfate, magnesium chloride, and magnesium sulfate is used as the water soluble salt, zinc chloride and zinc sulfate, which are zinc compounds, are particularly preferable. This is because the atomic weight of zinc is 65.4 whereas that of magnesium is 24.3, and hence it becomes necessary, in general, to include two to three times of the amount in parts by mass of magnesium compounds relative to a zinc compound, in order to attain the same effect as the zinc compound. Otherwise, ink absorptivity and clearness of image equivalent to the case where a zinc compound is used are difficult to obtain.

According to the present invention, it is possible to use, as the water soluble metal salt, in addition to zinc chloride, zinc sulfate, magnesium chloride, and magnesium sulfate as described above, known water soluble metal salts, as long as such water soluble metal salts do not reduce the effect of zinc chloride, zinc sulfite, magnesium chloride, and/or magnesium sulfate. Examples of the known water soluble metal salt include: 1) water soluble salt (nitrate, chloride, acetate, sulfate, lactate, etc.) of aluminum; 2) water soluble salt (chloride, nitrate, acetate, lactate, etc.) of magnesium; 3) water soluble salt (nitrate, chloride, acetate, sulfate, lactate, etc.) of sodium; 4) water soluble salt (nitrate, chloride, acetate, sulfate, lactate, etc.) of potassium; and 5) water soluble salt (nitrate, chloride, acetate, lactate, etc.) of zinc, which are commercially available.

The amount of the water soluble salt is preferably 0.5 to 30 parts by mass with respect to 100 parts by mass of pigment, and is more preferably adjusted within the range of 1 to 20 parts by mass. If the amount of the water soluble metal salt is less than 0.5 parts by mass, the coloring property of an image tends to be deteriorated whereas if the amount exceeds 30 parts by mass, lowering in the ink absorptivity, clearness of image, and print water resistance tend to occur, and uneven print tends to be generated.

It is possible to add various auxiliary agents, which are generally used for producing coated paper, in a suitable amount, to the ink receiving layer, such as a thickener, an antifoamer, a wetting agent, a surfactant, a coloring agent, an antistatic agent, a light resistance auxiliary agent, an UV absorber, an antioxidizing agent, and an antiseptic agent.

Although the coating amount of the ink receiving layer is not particularly limited, it is preferably 2 to 30 g/m², and more preferably 5 to 20 g/cm².

If the coating amount is less than the above-mentioned lower limit, the ink absorbing property, the clearness of image, and the image preservability tend to be deteriorated. If the coating amount is larger than the above-mentioned upper limit, the coating strength and the clearness of image tend to be decreased.

Note that the ink receiving layer may be formed by a plurality of layers as described above, and in such a case, the composition of each of the ink receiving layers may be the same or different from each other.

The ink receiving layer may be formed by using various known application devices, such as a blade coater, an air knife coater, a roil coater, a bar coater, a gravure coater, a rod blade coater, a lip coater, a curtain coater, and a die coater. It is possible to carry out a finishing process using a calender device, such as a machine calender, a super calender, and a soft calender.

(Printed Matter)

Printed matter may be produced by printing the ink jet recording sheet explained above with dye ink or pigment in using a printing device, such as a printer.

### Second Embodiment

The second embodiment of the present invention relates to an ink jet recording sheet in which the supporting medium of the first embodiment is a paper material, and to an ink jet recording sheet in which the Stöckigt sizing degree of the paper material is 110 seconds or longer.

Note that, according to the second embodiment of the present invention, the ink receiving layer may also be provided on both sides of the supporting medium. In such a case, it becomes possible to provide a clear print image on both sides of the ink jet recording sheet. Also, the ink receiving layer may be formed by a plurality of layers. Moreover, an undercoating layer may be provided between the supporting member and the ink receiving layer. Furthermore, an overcoating layer may be provided on the ink receiving layer in order to give glossiness or to improve the preservability, within a range not deteriorating the recording properties of the ink receiving layer.

Examples of the pulp which may be used as the main component of the paper material include: chemical pulp, such as L-bleached kraft pulp (LBKP) and N-bleached kraft pulp (NBKP); mechanical pulp, such as groundwood pulp (GP) and thermomechanical pulp (TMP); and pulp recycled from waste paper. These may be used in a mixture of two or more. Among these, it is preferable to use the LBKP as the main component of the pulp. Also, it is preferable to use chlorine-free pulp, such as ECF pulp and TCF pulp. Although the beating degree thereof is not particularly limited, it is preferable to beat until the freeness thereof reaches about 300 to 500 ml (CSF: JIS-P-8121). If the beating degree is too large, cockling when printed tend to occur and uneven absorption of ink tends to be readily caused. If the beating degree is too small, on the other hand, smoothness tends not to be obtained.

According to the present invention, an ink jet recording sheet may be obtained which has excellent surface strength and recording properties, and whose preservability of white paper portion will not be deteriorated even when pulp recycled from waste paper or mechanical pulp, which are generally avoided in use for ink jet recording sheets, may be utilized for the paper material. Examples of the source of waste paper include newspaper, magazines, paperboard, sealing paper, corrugated fiberboard, and printed matter. Also, broke of woodfree paper, coated paper, etc., which may be produced during the production thereof may be included in the waste paper. Pulp may be generally recycled from waste paper by subjecting waste paper and/or broke to, for example, a breaking process using a low concentration or high concentration pulper, a rough selection and well selection process using a screen or cleaner, a deinking process using flotation of water washing method, and a bleaching process using chlorine, chlorine dioxide, sodium hypochlorite, oxygen, etc., with a proper combination thereof.

It is possible to include, other than the above-mentioned pulp, filler in the paper material. The filler may be added to adjust air permeability, to impart opacity, and to adjust ink absorption of the paper material. Examples of the filler include clay, kaolin, sintered kaolin, talc, calcium carbonate, magnesium carbonate aluminum hydroxide, silica, titanium oxide, zeolite, and so forth. Among these, calcium carbonate is preferable because a paper material having high white degree may be obtained by using it.

It is preferable that 1 to 35 parts by weight of filler be contained with respect to 100 parts of the pulp. If the amount of filler is too small, not only will the level of white be lowered but also the absorption of ink tends to be decreased. If the amount of filler is too large, the rigidity and strength of paper tend to be lowered. Note that an addition of too large an amount of calcium carbonate may be a cause of yellowing of ink jet recording sheets.

The Stöckigt sizing degree of paper material used in the present invention may be adjusted by using a rosin type sizing agent; an internally adding sizing agent, such as alkenyl succinic anhydride, alkylketene dimer and petroleum resin type sizing agent; starch and derivatives thereof, such as rosin type starch, petroleum resin type starch, oxidized starch, acetylated starch and hydroxyethylated starch; polyvinyl alcohol and derivatives thereof; a synthetic resin including two or more of copolymers, such as styrene, alkyd, polyamide, acryl, olefin, maleic acid, and vinylacetate, and emulsion of these synthetic resins; and a wax type surface sizing agent.

In the present invention, the Stöckigt sizing degree of paper material is measured based on JIS P 8122, and it is 110 seconds or longer, preferably 200 seconds or longer and 380 seconds or shorter, and more preferably 240 seconds or longer and 360 seconds or shorter. If the Stöckigt sizing degree is less than 110 seconds, effects of the present invention, such as the improvement in the coloring properties for both the dye ink and pigment ink, and the improvement in the preservability of white paper portion may not be obtained even if the ink receiving layer of the present invention is formed due to the reason that components of the coating of the ink receiving layer probably permeate through the paper material or a binder component of the coating permeate through the paper material and decreases the surface strength of the coating. Note that if the Stöckigt sizing degree exceeds 380 seconds, coating materials tend to be repelled during the coating process.

A machining method is not particularly limited, and may be performed by using known machining devices, such as a Fourdrinier paper machine, cylinder paper machine, and twin-wire paper machine. Paper produced may be categorized into acidic paper and neutral paper depending on pH of the paper material, and both may be suitable used. By taking into account the preservability of the ink receiving layer, yellowing due to oxidization of cationic ink faxing agent in the ink receiving layer may be prevented by using the acidic paper as the paper material. By taking into account the preservability of base paper itself, on the other hand, if the acidic paper is used as the paper material, there is a problem that change in color and deterioration in quality tend to be easily generated due to the presence of sulfate ions which are produced from sulfate bands in the acidic paper. In such a case, if neutral paper is used as the paper material and an undercoating layer described below is formed, yellowing due to the oxidation of the cationic ink fixing agent in the ink receiving layer may be prevented due to the masking effect thereof, and it becomes possible to obtain an ink jet recording sheet having an excellent long term preservability for base paper.

Note that it is possible to apply/impregnate starches, polyvinyl alcohols, cationic resins, etc., onto the surface using a size pressing method, etc, and to adjust the flatness degree of the surface, and improve the strength and the print and writing properties thereof. Also, it is possible to carry out a smoothing process using a calender, etc., in order to improve the smoothness of the paper material. Note that although the basis weight of the paper material is not particularly limited, it is generally about 20 to 400 g/m².

(Undercoating Layer)

According to the present invention, although an ink receiving layer may be formed directly onto the paper material, it is possible to form an undercoating layer including pigment, an adhesive, etc., onto the supporting medium, and dispose the ink receiving layer onto the undercoating layer.

The pigment used for the undercoating layer is not particularly limited and may be one which is generally known in the field of coated paper production. Examples of the pigment include kaolin, clay, calcinated clay, amorphous silica, synthesized amorphous silica, zinc oxide, aluminum oxide, aluminum hydroxide, calcium carbonate, satin white, aluminum silicate, alumina, colloidal silica, zeolite, synthesized zeolite, sepiolite, smectite, synthesized smectite, magnesium silicate, magnesium carbonate, magnesium oxide, diatomaceous earth, styrene type plastic pigment, hydrotalcite, urea resin type plastic pigment, and benzoguanamin type plastic pigment. These may be used singularly or in a mixture of two or more. Among these, use of white pigment, such as calcium carbonate and plastic pigment, is preferable since an ink jet recording sheet having high degree of white may be obtained.

The adhesive used in the undercoating layer is not particularly limited, and it is possible to use conventionally known adhesives in the field of coated paper. Examples of the adhesive include: proteins, such as casein, soy bean protein, and synthesized protein; various starches, such as ordinary starch and oxidized starch; polyvinyl alcohols including denatured polyvinyl alcohols, such as polyvinyl alcohol, cationic polyvinyl alcohol, and silyl denatured polyvinyl alcohol; cellulose derivatives, such as carboxymethyl cellulose and methyl cellulose; conjugated diene polymer latex of styrene-butadiene copolymer and methylmethacrylate-butadiene copolymer; acryl type polymer latex; and vinyl polymer latex such as ethylene-vinyl acetate copolymer. These may be used singularly or in a mixture of two or more.

Although the mixing ratio of an adhesive to pigment depends on the kind thereof, it is generally adjusted to be within the range of 1 to 100 parts by mass, preferably 2 to 50 parts by mass, with respect to 100 parts by mass of pigment. Also, it is possible to add various auxiliary agents, which are generally used for producing coated paper, in a suitable amount, such as a dispersing agent, a thickener, an antifoamer, an antistatic agent, and an antiseptic agent. Moreover, it is possible to add a fluorescent dye, a coloring agent, white pigment, etc, in the undercoating layer.

The undercoating layer may be formed by applying a coating solution including the above-mentioned components using a known method. For instance, the coating solution may be applied using various known application devices, such as a blade coater, an air knife coater, a roll coater, a bar coater, a gravure coater, a rod blade coater, a lip coater, a curtain coater, and a die coater, such as a slide bead, a slide hopper and a die coater. It is possible to form the undercoating layer immediately after the paper material is formed using a coating device which is provided in the same process of a paper machine, a so-called on-machine.

(Ink Receiving Layer)

The ink receiving layer include al least pigment, an adhesive, a cationic ink fixing agent, and a water soluble metal salt.

As for pigment used in the ink receiving layer, those mentioned in the First Embodiment may also be suitably used. As described above, among these pigments, it is preferable to use silica, alumina, pseudoboehmite, precipitated calcium carbonate, and zeolite due to their excellent coloring and ink absorbing properties. Among them, it is more preferable to use silica, alumina, and pseudoboehmite, and it is most preferable to use silica.

As for the above-mentioned silica, use of amorphous silica is preferable. Methods for producing the silica are not particularly limited, and it may be produced by using an arc method, a dry method, a wet method (precipitation method, gel method), and so forth. Among these methods, the wet method is preferable since the silica produced by the method is suitable for the ink jet recording sheet for pigment ink as well as the ink jet recording sheet for dye ink.

In this embodiment of the present invention, it is preferable that the average particle size of the secondary particle of silica is 11 μm or less, and it is more preferable that the average particle size of the secondary particle of silica be 2 to 10 μm. If the average particle size of the secondary particle of the wet silica exceeds 11 μm, problems tend to occur for the ink jet recording sheet for dye ink as well as for the ink jet recording sheet for pigment ink, such as lowering in clearness of image and the generation of blurring of image due to surface roughness. If the average particle size is less than 2 μm, on the other hand, the absorptivity for dye ink of the ink jet recording sheet which includes such silica tends to be reduced. Also, since the light transmittance thereof will increase, light resistance of the image formed by dye ink as well as the coating strength tends to be reduced. Moreover, when this is used for ink jet recording sheet for pigment ink, disadvantages such as lowering in the fixation property of the pigment ink will occur.

According to this embodiment of the present invention, it is also preferable that the surface of at least a part of the pigment contained in the ink receiving layer be treated with a surfactant. That is, the surface of all of the pigment nay be treated with a surfactant, or it is possible to use the surface treated pigment together with untreated pigment. Since the methods for treating the surface of pigment are the same as those described above, explanation thereof will be omitted.

The amount of surfactant added is preferably 0.1 to 30 parts, more preferably 0.5 to 20 parts, with respect to 100 parts of pigment. When silica which is covered by the surfactant within the above-mentioned range is included, it becomes possible to improve the coloring property and to obtain a clear image.

The adhesive which may be used in the ink receiving layer is the same as those described in the First Embodiment of the present invention, and hence the explanation thereof will be omitted here. These adhesives may be used singularly or in combination of two or more.

According to this Embodiment of the present invention, a cationic ink fixing agent and a water soluble metal salt are included in the ink receiving layer in order to fix the ink. As the water soluble metal salt, one having bivalency or more is preferable. The term “water soluble metal salt having bivalency or more” means water soluble metal salt which generates a cation of two valency or more when dissolved in water and dissociated. As such a metal salt, although one which is water soluble and has valency of two or more is suitably used, it is preferable to use two valency metal salt, and it is more preferable to use metals salts of zinc or magnesium, such as zinc chloride, zinc sulfate, magnesium chloride, and magnesium sulfate.

According to this embodiment of the present invention, it is possible to use other known water soluble metal salt as long as it does not deteriorate the effect of the (bivalency) metal ion of the above-mentioned water soluble metal salt. Examples of the known water soluble metal salt include: 1) water soluble salt (nitrate, chloride, acetate, sulfate, lactate, etc.) of aluminum; 2) water soluble salt (nitrate, chloride, acetate, sulfate, lactate, etc.) of sodium; and 3) water soluble salt (nitrate, chloride, acetate, sulfate, lactate, etc) of potassium, which are commercially available.

The amount of the water soluble salt is preferably 0.5 to 30 parts by mass with respect to 100 parts by mass of pigment, and is more preferably adjusted within the range of 1 to 20 parts by mass. If the amount of the water soluble metal salt is less than 0.5 parts by mass, the coloring property of an image tends to be deteriorated, whereas if the amount exceeds 30 parts by mass, lowering in the ink absorptivity, clearness in image, and print water resistance tend to occur, and uneven printing tends to be generated.

On the other hand, the cationic ink fixing agent used in the ink receiving layer is not particularly limited, and examples thereof include 1) polyalkylene polyamines or derivatives thereof, such as polyethylene amine and polypropylene polyamine; 2) acryl polymer having a secondary or tertiary amine group and/or a quaternary ammonium group; 3) polyvinyl amine, polyvinyl amidine, and 5-member ring amidines; 4) dicyan type cation resins, represented by dicyandiamide-formalin copolymer, 5) polyamine type cation resins, represented by dicyandiamide-polyethylene amine copolymer 6) dimethylamino-epichlorohydrin copolymer, 7) diallyldimethyl ammonium-SO₂ copolymer; 8) diallylamine salt-SO₂ copolymer; 9) dimethyldiallyl ammonium chloride polymer; 10) polymer of allyl amine salt; 11) homopolymer or copolymer of vinylbenzyl triallylammonium salt; 12) dialkylaminoethyl(meth)acrylate quaternary salt copolymer, 13) acryl amide-diacryl amine salt copolymer; and 14) aluminum salts, such as aluminum polychloride and aluminum polyacetate; which are commercially available. These may be used singularly or in a mixture of two or more.

Among the above, it is preferable to use, as the cationic ink fixing agent, a dicyandiamide-polyethyleneamine copolymer together with an acrylamide-diallyl amine copolymer. By using the dicyandiamide-polyethyleneamine copolymer together with the acrylamide-diallyl amine copolymer, excellent coloring property when printed using pigment ink and excellent coloring property and print preservability (especially, print light resistance and print ozone resistance) when printed using dye ink may be obtained.

The amount of the cationic fixing agent is adjusted to be 5 to 60 parts by mass, preferably 20 to 50 parts by mass, with respect to 100 parts by mass of pigment. If the amount of the cationic polymer is less than 5 parts by mass, coloring of image and the preservability of printed portion will be easily deteriorated. If the amount of the cationic polymer exceeds 60 parts by mass, on the other hand, the ink absorptivity and the clearness of image will be deteriorated and uneven color will be caused.

In this embodiment of the present invention, by using at least one of the above-mentioned water soluble metal salt together with a cationic compound and applying these onto a paper material having the Stöckigt sizing degree of 110 seconds or more, the coloring properties for both dye ink and pigment ink will be improved, although the exact reason causing such improvement is not yet known. In particular, a very clear image may be obtained when printed using pigment ink, and the preservability of the white paper portion is also improved.

Also, as described above, it is possible to add various auxiliary agents, which are generally used for producing coated paper, in a suitable amount, to the ink receiving layer, such as a thickener, an antifoamer, a wetting agent, a surfactant, a coloring agent, an antistatic agent, a light resistance auxiliary agent, an UV absorber, an antioxidizing agent, and an antiseptic agent.

Although the coating amount of the ink receiving layer is not particularly limited, it is preferably 2 to 30 g/m², and more preferably 5 to 20 g/cm² as described above. If the coating amount is less than the abovementioned lower limit, the ink absorbing property, the clearness of image, and the image preservability tend to be deteriorated. If the coating amount is larger than the above-mentioned upper limit, the coating strength and the clearness of image tend to be decreased. Note that the ink receiving layer may be formed by a plurality of layers as described above, and in such a case, the composition of each of the ink receiving layers may be the same or different from each other.

As described above, the ink receiving layer may be formed by using various known application devices, such as a blade coater, an air knife coater, a roll coater, a bar coater, a gravure coater, a rod blade coater, a lip coater, a curtain coater, and a die coater. It is possible to carry out a finishing process using a calender device, such as a machine calender, a super calender, and a soft calender.

(Printed Matter)

Printed matter may be produced by printing the ink jet recording sheet explained above with dye ink or pigment ink using a printing device, such as a printer.

### EXAMPLES

Hereinafter, the present invention will be explained in detail with reference to Examples. However, it is apparent that the present invention is not limited to these Examples. Also, “parts” and “%” used in the examples indicate “parts by mass” and “% by mass” of a solid component excluding water unless otherwise so indicated.

Print concentration, print light resistance, and print ozone resistance of ink jet recording sheet which was obtained in each of Examples and Comparative Examples were evaluated using the methods described below.

### Example 1

(Preparation of Surface Treated Silica A)

Wet silica (900 g, a product of Tokuyama Corporation, product name: Finesil X-60) was suspended in water to obtain a slurry (about 10 to 15%), and 101 g of a water-suspension of a surfactant (polyoxyethylenelauryl ether, product name: Noigen ET-102, a product of Dai-ichi Kogyo Seiyaku Co. Ltd., HLB-L 10.8) was added to the slurry. The mixture was stirred for one hour, spray-dried, pulverized, and classified to obtain the surface treated silica A of the present invention. The average secondary particle size of the obtained surface treated silica A was 6 μm.

(Preparation of Ink Receiving Layer Coating Solution)

An ink receiving layer coating solution A was prepared by mixing and dispersing 80 parts of wet silica (a product of Tokuyama Corporation, product name: Finesil X-60) as pigment, 20 parts of the surface treated silica A obtained as described above, 20 parts of silyl denatured PVA (a product of Kuraray Co. Ltd., product name: R-1130) and 20 parts of ethylene-vinyl acetate copolymer (a product of Showa Highpolymer Co., Ltd., product name: Polysol AM-3000, an emulsion type adhesive), 30 parts of dicyandiamide-polyethylene amine copolymer (a product of Nicca Chemical Co. Ltd., product name: Neofix IJ-117) as an ink fixing agent, 5 parts of an aqueous solution of zinc chloride (a product of Wako Pure Chemical Industries, Ltd., a 5% solution was prepared by dissolving zinc chloride in water, Molecular weight: 136.30), and water.

(Preparation of Ink Jet Recording Sheet)

The ink receiving layer coating solution A was applied onto a surface of woodfree paper of 170 g/m² and was dried to obtain an ink jet recording sheet.

Evaluation was made for the ink jet recording sheet obtained for each of the test items described below.

### Example 2

An ink jet recording sheet was prepared in the same manner as described in Example 1 except that the zinc chloride aqueous solution in the ink receiving layer coating solution of Example 1 was changed to 10 parts of zinc sulfate aqueous solution (a product of Wako Pure Chemical Industries, Ltd., a 5% solution was prepared by dissolving zinc sulfate 7 hydrate in water, Molecular weight: 287.56).

### Example 3

An ink jet recording sheet was prepared in the same manner as described in Example 1 except that the zinc chloride aqueous solution in the ink receiving layer coating solution of Example 1 was changed to 20 parts of a magnesium chloride aqueous solution (a product of Wako Pure Chemical Industries, Ltd., a 5% solution was prepared by dissolving magnesium chloride 6 hydrate in water, Molecular weight: 203.30).

### Example 4

An ink jet recording sheet was prepared in the same manner as described in Example 1 except that the zinc chloride aqueous solution in the ink receiving layer coating solution of Example 1 was changed to 20 parts of a magnesium sulfate aqueous solution (a product of Wako Pure Chemical Industries, Ltd., a 5% solution was prepared by dissolving magnesium sulfate 7 hydrate in water, Molecular weight: 246.48),

### Example 5

An ink jet recording sheet was prepared in the same manner as described in Example 1 except that the ink fixing agent in the ink receiving layer coating solution of Example 1 was changed to 15 parts of dicyandiamide-polyethylene amine copolymer (a product of Nicca Chemical Co. Ltd., product name: Neofix 11-117), 15 parts of an aqueous solution of zinc chloride (a product of Wako Pure Chemical Industries, Ltd., a 5% solution was prepared by dissolving zinc chloride in water, Molecular weight: 136.30).

### Example 6

An ink jet recording sheet was prepared in the same manner as described in Example 1 except that the pigment in the ink receiving layer coating solution of Example 1 was changed to 100 parts of wet silica (a product of Tokuyama Corporation, product name: Finesil X-60).

### Comparative Example 1

An ink jet recording sheet was prepared in the same manner as described in Example 6 except that the zinc chloride aqueous solution was removed from the ink receiving layer coating solution of Example 6.

### Comparative Example 2

An ink jet recording sheet was prepared in the same manner as described in Example 6 except that the zinc chloride aqueous solution in the ink receiving layer coating solution of Example 6 was changed to 30 parts of aluminum sulfate (a product of Wako Pure Chemical Industries, Ltd., a 5% solution was prepared by dissolving aluminum sulfate hydrate in water, Molecular weight: 594.35).

### Comparative Example 3

An ink jet recording sheet was prepared in the same manner as described in Example 6 except that the zinc chloride aqueous solution in the ink receiving layer coating solution of Example 6 was changed to 5 parts of sodium chloride (a product of Wako Pure Chemical Industries, Ltd., a 5% solution was prepared by dissolving sodium chloride in water, Molecular weight; 58.44).

### Comparative Example 4

An ink jet recording sheet was prepared in the same manner as described in Example 6 except that the ink firing agent in the ink receiving layer coating solution of Example 6 was changed to 30 parts of acrylamide-diallyl amine copolymer (a product of Sumitomo Chemical Co. Ltd., product name. SR 1001) and 5 parts of zinc chloride aqueous solution (a product of Wako Pure Chemical Industries, Ltd., a 596 solution was prepared by dissolving zinc chloride in water, Molecular weight: 136.30).

### Comparative Example 5

An ink jet recording sheet was prepared in the same manner as described in Example 6 except that the ink fixing agent in the ink receiving layer coating solution of Example 6 was changed to 30 parts of polydiallyldimethylammonium chloride (a product of Senka Co. Ltd., product name: Unisence CP101) and 5 parts of zinc chloride aqueous solution (a product of Wako Pure Chemical Industries, Ltd., a 5% solution was prepared by dissolving zinc chloride in water, Molecular weight: 136.30).

Evaluation:

The print concentration, print light resistance, and print ozone resistance of the ink jet recording sheet obtained in each of Examples and Comparative Examples are evaluated by the devices and methods described below. Results of the evaluation are tabulated in Table 2.

(Printer A)

A commercially available dye ink jet printer (a product of SEIKO EPSON Corporation, trade name: PM-G800; print mode: Fotomat paper/high fineness).

(Printer B)

A commercially available dye ink jet plotter (a product of SEIKO EPSON Corporation, trade name: PX-9000; ink: Mat black; print mode: PXMC premium mat paper/clean).

(Printer C)

A commercially available dye ink jet plotter (a product of Hewlett-Packard Co., trade name; Design Jet 5500; ink: pigment ink; print mode: best quality).

(Print Concentration)

Image issued by Japanese Standards Association (high fineness color digital standard image XYZ/JIS-SCID), Identification Number: S6; Image title: Color Chart) was printed using the above-mentioned three types of ink jet printers A to C, and the print concentration of the best black tone portion was measured using a measuring device of “RD-914”, a product of Gretag Macbeth Co.

(Print Light Resistance)

Printed matter which was printed using the above-mentioned ink jet printer A (dye ink type) in which the discharge amount of magenta was adjusted to be 80% using a commercially available image processing software, was irradiated with a xenon lamp having illuminance of 100 klux under the conditions of 65° C. and 40% RH for 72 hours and the print concentration thereof was measured. The light resistance of the printed portion was evaluated based on the standard described below using the following equation for calculating the remaining rate of the print concentration:
Print concentration remaining rate (%)=(print concentration after irradiation/print concentration before irradiation)×100
(Print Ozone Resistance)

Printed matter which was printed using the above-mentioned ink jet printer A (dye ink type) in which the discharge amount of magenta was adjusted to bc 80% using a commercially available image processing software, was left in an atmosphere of 2.5 ppm ozone concentration under the condition of 24° C. and 60%. RH for 24 hours and the print concentration thereof was measured. The ozone resistance of the printed portion was evaluated based on the standard described below using the following equation for calculating the remaining rate of the print concentration:
Print concentration remaining rate (%)=(print concentration after being left/print concentration before being left)×100

In order to make clear the difference in ingredients of each of the above Examples and Comparative Examples, the contents of each are tabulated in Table 1 as follows.

TABLE 1

| | | | | Presence of |
|---|---|---|---|---|
| | Cationic | Cationic | Water soluble metal | surface |
| | resin 1 | resin 2 | salt | treated silica |
| Ex. 1 | guanidine | none | zinc chloride | present |
| Ex. 2 | guanidine | none | zinc sulfate | present |
| Ex. 3 | guanidine | none | magnesium chloride | prescnt |
| Ex. 4 | guanidine | none | magnesium sulfate | present |
| Ex. 5 | guanidine | secondary | zinc chloride | present |
| | | ammonium | | |
| | | salt | | |
| Ex. 6 | guanidine | none | zinc chloride | none |
| C. Ex. 1 | guanidine | none | none | none |
| C. Ex. 2 | guanidine | none | aluminum sulfate | none |
| C. Ex. 3 | guanidine | none | sodium chloride | none |
| C. Ex. 4 | secondary | none | zinc chloride | none |
| | ammonium | | | |
| | salt | | | |
| C. Ex. 5 | quaternary | none | zinc chloride | none |
| | ammonium | | | |
| | salt | | | |

TABLE 2
Results:

| | Print | | | Print | Print |
|---|---|---|---|---|---|
| | concentration | | | light | ozone |
| | | Printer B | Printer C | resistance | resistance |
| | Printer A | (pigment | (pigment | Printer A | Printer A |
| | (dye ink) | ink) | ink) | (dye ink) | (dye ink) |
| Ex. 1 | 1.85 | 1.84 | 1.64 | 70% | 93% |
| Ex. 2 | 1.85 | 1.85 | 1.64 | 71% | 93% |
| Ex. 3 | 1.87 | 1.81 | 1.61 | 71% | 93% |
| Ex. 4 | 1.87 | 1.81 | 1.61 | 70% | 94% |
| Ex. 5 | 1.88 | 1.80 | 1.62 | 85% | 92% |
| Ex. 6 | 1.82 | 1.80 | 1.60 | 70% | 93% |
| C. Ex. 1 | 1.82 | 1.70 | 1.50 | 62% | 92% |
| C. Ex. 2 | 1.81 | 1.72 | 1.52 | 67% | 92% |
| C. Ex. 3 | 1.79 | 1.73 | 1.52 | 63% | 92% |
| C. Ex. 4 | 1.84 | 1.73 | 1.52 | 91% | 93% |
| C. Ex. 5 | 1.87 | 1.80 | 1.62 | 51% | 71% |

As is clearly shown in Table 2 above, it is obvious that all of the ink jet recording sheets according to the present invention have an excellent and better print concentration property, etc., as compared with the recording sheets of Comparative Examples. Therefore, according to the present invention, it becomes possible to provide an ink jet recording sheet which has excellent recording properties and print preservability for dye ink as well as pigment ink.

### Example 7

(Preparation of Paper Material A)

Precipitated calcium carbonate light (20 parts) was added to a slurry of 100 parts of hardwood kraft pulp (freeness 400 ml CSF), and 1 part of cation starch (a product of Oji Cornstarch Co., Ltd, product name: Ace K) and 0.2 parts of alkenylsuccinic anhydride type neutral sizing agent (a product of National Starch and Chemical Co., Ltd., product name: Phibrun 81K) were added, sufficiently mixed, and paper raw material was obtained. This was dried using Fourdrinier multi-cylinder paper machine until water content thereof became 10%. Then, 7% sizepressing solution, which included 100 pats of oxidized starch (a product of Oji Cornstarch Co., Ltd, product name: Ace A) and 3 parts of styrene type surface sizing agent (a product of Arakawa Chemical Industries, Ltd., product name: Polymalon 360), was applied to both sides in an amount of 4 g/m², and dried until water components thereof became 7% to produce a paper material A of 200 g/m². The Stöckigt sizing degree of the paper material A was 260 seconds.

(Ink Receiving Layer Coating Solution A)

Wet silica (100 parts, a product of Tokuyama Corporation, product name: Finesil X-60, secondary particle size of 6.2 μm) as pigment, Silyl denatured polyvinyl alcohol (30 parts, a product of Kuraray Co. Ltd., product name: R-1130) as adhesive, acrylamide-diallyl amine copolymer (15 parts, a product of Sumitomo Chemical Co. Ltd., product name: SR 1001) and dicyandiamide-polyethylene amine copolymer (15 parts, a product of Nicca Chemical Co. Ltd., product name: Neofix IJ-117) as an ink fixing agent, 5 parts of an aqueous solution of zinc chloride (a product of Wako Pure Chemical Industries, Ltd., a 5% solution was prepared by dissolving zinc chloride in water, Molecular weight: 136.30), and water were mixed and dispersed to obtain the ink receiving layer coating solution A.

(Preparation of Ink Jet Recording Sheet)

The ink receiving layer coating solution A was applied onto the paper material A so that the coating amount became 10 g/m², and it was dried to obtain an ink jet recording sheet. Note that the 60° specular surface gloss of a white paper portion in the ink receiving layer of the obtained ink jet recording sheet based on JIS-Z8741 was 3%.

### Example 8

An ink jet recording sheet was prepared in the same manner as described in Example 7 except that the zinc chloride aqueous solution in the ink receiving layer coating solution of Example 7 was changed to 10 parts of zinc sulfate aqueous solution (a product of Wako Pure Chemical Industries, Ltd., a 5% solution was prepared by dissolving zinc sulfate 7 hydrate in water, Molecular weight; 287.56).

### Example 9

An ink jet recording sheet was prepared in the same manner as described in Example 7 except that the zinc chloride aqueous solution in the ink receiving layer coating solution of Example 7 was changed to 20 parts of a magnesium chloride aqueous solution (a product of Wako Pure Chemical Industries, Ltd., a 5% solution was prepared by dissolving magnesium chloride 6 hydrate in water, Molecular weight: 203.30).

### Example 10

(Preparation of Paper Material B)

Precipitated calcium carbonate light (20 parts) was added to a mixed slurry of 70 parts of hardwood kraft pulp (freeness 400 ml CSF) and 30 parts of pulp obtained by subjecting old newspaper to a deinking process, and 1 part of cation starch (a product of Oji Cornstarch Co., Ltd., product name: Ace K) and 0.2 parts of alkenylsuccinic anhydride type neutral sizing agent (a product of National Starch and Chemical Co., Ltd., product name: Phibrun 81K) were added, sufficiently mixed, and paper raw material was obtained. This was dried using a Fourdrinier multi-cylinder paper machine until the water content thereof became 10%. Then, 7% sizepressing solution, which included 100 parts of oxidized starch (a product of Oji Cornstarch Co., Ltd., product name: Ace A) and 3 parts of styrene type surface sizing agent (a product of Arakawa Chemical Industries, Ltd., product name: Polymalon 360), was applied to both sides in an amount of 4 g/m², and this was dried until water components thereof became 7% to produce a paper material B of 200 g/m². The Stöckigt sizing degree of the paper material A was 280 seconds.

(Preparation of Ink Jet Recording Sheet)

An ink jet recording sheet was prepared in the same manner as described in Example 7 except that the paper material B was used instead of the paper material A. Note that the 60° specular surface gloss of a white paper portion of the ink receiving layer of the obtained ink jet recording sheet based on JIS-Z8741 was 3%.

### Example 11

(Preparation of Surface Treated Silica A′)

As in Example 1, wet silica (900 g, a product of Tokuyama Corporation, product name: Finesil X-60) was suspended in water to obtain a slurry (about 10 to 15%), and 100 g of a water-suspension of a surfactant (polyoxyethylenelauryl ether, product name: Noigen ET-102, a product of Dai-ichi Kogyo Seiyaku Co. Lid, HLB: 10.8) was added to the slurry. The mixture was stirred for one hour, spray-dried, pulverized, and classified to obtain the surface treated silica A of the present invention. The average secondary particle size of the obtained surface treated silica A′ was 6 μm.

(Ink Receiving Layer Coating Solution B)

Wet silica (80 parts, a product of Tokuyama Corporation, product name: Finesil X-60, secondary particle size of 6.2 μm) and 20 parts of the surface treated silica A′ obtained as above as pigment, silyl denatured polyvinyl alcohol (20 parts, a product of Kuraray Co. Ltd., product name: R-1130) and 20 parts of ethylene-vinyl acetate copolymer (a product of Showa Highpolymer Co., Ltd., product name: Polysol AM-3000, an emulsion type adhesive) as adhesive, acrylamide-diallyl amine copolymer (15 parts, a product of Sumitomo Chemical Co. Ltd., product name: SR 1001) as an ink fixing agent and dicyandiamide-polyethylene amine copolymer (15 parts, a product of Nicca Chemical Co. Ltd, product name: Neofix IJ-117), 0.5 parts of an aqueous solution of zinc chloride (a product of Wako Pure Chemical Industries, Ltd., a 5% solution was prepared by dissolving zinc chloride in water, Molecular weight: 136.30), and water were mixed and dispersed to obtain the ink receiving layer coating solution A.

(Preparation of Ink Jet Recording Sheet)

The ink receiving layer coating solution B was applied onto one surface of woodfree paper of 170 g/m² (Stöckigt sizing degree of 260 seconds) so that the coating amount of the ink receiving layer coating solution became 10 g/m², and this was dried to obtain an ink jet recording sheet.

### Comparative Example 6

An ink jet recording sheet was obtained in the same manner as in Example 7 except that paper material which was not subjected to the size pressing treatment was used (Stöckigt sizing degree of 20 seconds).

### Comparative Example 7

An ink jet recording sheet was obtained in the same manner as in Example 7 except that the zinc chloride aqueous solution was not used for the ink receiving layer coating solutions

### Comparative Example 8

An ink jet recording sheet was obtained in the same manner as in Example 7 except that the zinc chloride aqueous solution in the ink receiving layer coating solution of Example 7 was changed to 30 parts of aluminum sulfate (a product of Wako Pure Chemical Industries, Ltd., a 5% solution was prepared by dissolving aluminum sulfate hydrate in water, Molecular weight: 594.35).

### Comparative Example 9

An ink jet recording sheet was prepared in the same manner as described in Example 7 except that the zinc chloride aqueous solution in the ink receiving layer coating solution of Example 7 was changed to 5 parts of sodium chloride (a product of Wako Pure Chemical Industries, Ltd., a 5% solution was prepared by dissolving sodium chloride in water, Molecular weight: 58.44).

### Comparative Example 10

An ink jet recording sheet was prepared in the same manner as described in Example 7 except that the ink fixing agent in the ink receiving layer coating solution of Example 7 was changed to 30 parts of polydiallyldimethylammonium chloride (a product of Senka Co. Ltd., product name: Unisence CP101) and 5 parts of zinc chloride aqueous solution (a product of Wako Pure Chemical Industries, Ltd., a 5% solution was prepared by dissolving zinc chloride in water, Molecular weight: 136.30).

Evaluation:

The print concentration, print light resistance, and print ozone resistance of the ink jet recording sheet obtained in each of Examples 7 to 11 and Comparative Examples 6 to 10 are evaluated by the devices and methods described above. Accordingly, the explanation thereof will be omitted. Furthermore, preservability of the white paper portion against heat and humidity, preservability of the white paper portion against light, and a coating film strength of the ink jet recording sheet obtained in each of Examples 7 to 11 and Comparative Examples 6 to 10 are evaluated by the methods described below. Results of the evaluation are tabulated in Table 3.

(Print Concentration)

The same method for evaluation as describe above was used.

(Print Light Resistance)

The same method for evaluation as describe above was used.

(Print Ozone Resistance)

The same method for evaluation as describe above was used.

(Preservability of White Paper Portion (Yellowing Resistance Against Heat and Humidity))

The ink jet recording shoot of each Example and Comparative Example was left for one week under an environment of 80° C. and 50% humidity. The degree of yellowing of the white paper portion at the ink receiving layer side before and after the test was visually determined based on the criteria described below:
◯: almost no yellowing caused;
Δ: yellowing caused; and
X: abundant yellowing.
   (Preservability of White Paper Portion (Yellowing Resistance Against Light))

The ink jet recording sheet of each Example and Comparative Example was irradiated by a xenon lamp (100,000 lux) for three days under an environment of 60° C. and 50% humidity. The degree of yellowing of the white paper portion at the ink receiving layer side before and after the test was visually determined based on the criteria described below:
◯: almost no yellowing caused;
Δ: yellowing caused; and
X: abundant yellowing.
   (Coating Strength)

An adhesive tape was attached to the surface of the ink receiving layer of the ink jet recording sheet of each Example and Comparative Example, and after a weight of 1 kg was placed on the adhesive tape, the weight was removed, and the adhesive tape was peeled off. The surface of the tape and coating layer was visually observed and evaluated as follows:
◯: although minor attachments were observed on the tape, no change on the coating surface was observed;
Δ: attachments were observed on the tape, and peeled-off portions were slightly observed; and

X: abundant attachments were observed on the tape, and peeled-off portions were conspicuous.

TABLE 3
Results:

| | Print | | | Print | Print |
|---|---|---|---|---|---|
| | concentration | | | light | ozone |
| | | Printer B | Printer C | resistance | resistance |
| | Printer A | (pigment | (pigment | Printer A | Printer A |
| | (dye ink) | ink) | ink) | (dye ink) | (dye ink) |
| Ex. 7 | 1.87 | 1.86 | 1.64 | 70% | 93% |
| Ex. 8 | 1.87 | 1.85 | 1.64 | 71% | 93% |
| Ex. 9 | 1.85 | 1.84 | 1.61 | 71% | 93% |
| Ex. 10 | 1.87 | 1.85 | 1.63 | 69% | 92% |
| Ex. 11 | 1.88 | 1.88 | 1.65 | 75% | 92% |
| C. Ex. 6 | 1.85 | 1.84 | 1.64 | 70% | 91% |
| C. Ex. 7 | 1.85 | 1.72 | 1.52 | 65% | 92% |
| C. Ex. 8 | 1.83 | 1.73 | 1.52 | 63% | 92% |
| C. Ex. 9 | 1.84 | 1.74 | 1.52 | 63% | 91% |
| C. Ex. 10 | 1.90 | 1.85 | 1.64 | 52% | 70% |

| | Yellowing | | |
|---|---|---|---|
| | resistance | Yellowing | |
| | (heat & | resistance | Coating |
| | humidity) | (light) | strength |
| Ex. 7 | ◯ | ◯ | ◯ |
| Ex. 8 | ◯ | ◯ | ◯ |
| Ex. 9 | ◯ | ◯ | ◯ |
| Ex. 10 | ◯ | ◯ | ◯ |
| Ex. 11 | ◯ | ◯ | ◯ |
| C. Ex. 6 | Δ | Δ | Δ |
| C. Ex. 7 | Δ | Δ | Δ |
| C. Ex. 8 | Δ | Δ | Δ |
| C. Ex. 9 | Δ | Δ | Δ |
| C. Ex. 10 | ◯ | ◯ | ◯ |

As is clearly shown in Table 3 above, it is also obvious that all of the ink jet recording sheets according to the present invention have an excellent and better yellowing resistance and coating strength, etc., as compared with the recording sheets of Comparative Examples. Therefore, according to the present invention, it becomes possible to provide an ink jet recording sheet which has excellent recording properties, print preservability, yellowing resistance and coating strength for dye ink as well as pigment ink.

Having thus described exemplary embodiments of the invention, it will be apparent that various alterations, modifications, and improvements will readily occur to those skilled in the art. Such alterations, modifications, and improvements, though not expressly described above, are nonetheless intended and implied to be within the spirit and scope of the invention. Accordingly, the foregoing discussion is intended to be illustrative only: the invention is limited and defined only by the following claims and equivalents thereto.

1. Ink jet recording sheet, comprising:
a supporting medium; and
an ink receiving layer disposed on said supporting medium, said ink receiving layer including, at least: pigment; an adhesive; and an ink fixing agent, wherein said ink fixing agent includes at least one compound selected from the group consisting of zinc chloride, zinc sulfate, magnesium chloride and magnesium sulfate, in combination with a guanidine compound.

2. The ink jet recording sheet according to claim 1, wherein said guanidine compound is a dicyandiamide-polyethylene amine copolymer.

3. The ink jet recording sheet according to claim 1 or 2 above, further comprising: a secondary ammonium salt compound as said ink fixing agent.

4. The ink jet recording sheet according to claim 3, wherein said secondary ammonium salt compound is a compound having an acrylamide-diallyl amine structure.

5. The ink jet recording sheet according to claim 1, wherein said pigment has an average secondary particle size of 2 to 12 μm.

6. The ink jet recording sheet according to claim 1, wherein said ink receiving layer further comprising surface-treated silica whose surface has been treated by a surfactant.

7. The ink jet recording sheet according to claim 1, wherein said supporting medium is a paper material.

8. The ink jet recording sheet according to claim 7, wherein a Stöckigt sizing degree of said paper material is 110 seconds or longer.

9. The ink jet recording sheet according to claim 7, wherein 10% or more of pulp which forms said paper material is recycled pulp obtained from waste paper.

10. The ink jet recording sheet according to claim 1, wherein a 600 specular gloss defined by JIS-Z8741 of a surface of the ink jet recording sheet is 15% or less.

11. Printed matter including the ink jet recording sheet according to any one of claims 1 to 10, which is printed using a dye ink.

12. Printed matter including the ink jet recording sheet according to any one of claims 1 to 10, which is printed using a pigment ink.
